(19) United States
(12) Patent Application Publication
(10) Pub. No.: US 2007/0172336 A1
(43) Pub. Date: Jul. 26, 2007

(54) MOUNTING BUTTON USED IN DISPLAY MODULE

(76) Inventor: Yao-Tung Hsu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/308,969

(22) Filed: Jun. 1, 2006

(30) Foreign Application Priority Data
Jan. 24, 2006 (TW) 95102573

(51) Int. Cl. F16B 19/00

(52) U.S. Cl. 411/508

(57) ABSTRACT

A mounting button suitable for fixing the relative position of a first plate and a second plate in a display module is provided. The first plate has a first opening and the second plate has a second opening. The mounting button comprises a shaft, a first sticking part, a second sticking part, and a spacing part, wherein the first sticking part, the second sticking part, and the spacing part protrude from the shaft, and the spacing part is located between the first sticking part and the second sticking part. The mounting button used in the display module permits quicker assembly and disassembly for improving the efficiency of production and repair.

### CROSS-REFERENCE TO RELATED APPLICATION

This application claims the priority benefit of Taiwan application serial no. 95102573, filed on Jan. 24, 2006. All disclosure of the Taiwan application is incorporated herein by reference.

### BACKGROUND OF THE INVENTION

1. Field of Invention

The present invention relates to a mounting button. More particularly, the present invention relates to a mounting button used in a display module.

2. Description of Related Art

The Flat Panel Display is a kind of communication interface between humans and information. Currently, Flat Panel Displays mainly include Plasma Displays, Organic Electro-Luminescent Displays (OELD), Liquid Crystal Displays (LCD), etc. Among them, the Plasma Display has large application potential due to its advantages of large size, self-luminescence, no visual angle dependence, lightness and thinness, true color, and so on, and will hopefully become the mainstream of the next-generation of Flat Panel Displays.

Along with the trend of large size of the Plasma Display, besides display quality, manufacturing cost of the display is also an important factor to be taken into consideration. Currently, during the manufacture of the Plasma Display, the cost of the mechanism comprises a large proportion. Therefore, during the manufacture of the display, the design and development of the mechanism are quite important.

In a conventional Plasma Display, the plasma display panel is disposed on one side surface of a back plate. The plasma display panel is coupled to a circuit board disposed on the other side of the back plate by a flexible package, for example, a Tape Carrier Package (TCP), so as to be driven by the driving chip on the soft package and the circuit board to display images. Moreover, in order to prevent the driving chip and the circuit board from generating a high temperature during operation, which may affect signal and display quality, a heat sink is usually disposed on the back plate to dissipate the heat of the flexible package and the circuit board.

FIG. 1 is a partial schematic view of a heat sink and a back plate in a conventional Plasma Display. Referring to FIG. 1, an edging 102 is often formed on the edge of the back plate 100 of the Plasma Display, and a heat sink 110 is disposed beside the back plate 100. The edging 102 and the heat sink 110 are locked by a screw 120. The screw 120 sequentially passes through the heat sink 110, a spacing nut 122, the edging 102 of the back plate 100 and a nut 124 from the outer side of the heat sink 110, so as to lock the edging 102 of the back plate 100 and the heat sink 110 together. The spacing nut 122 is used to keep a distance between the edging 102 of the back plate 100 and the heat sink 110.

Based on the manner of assembly, when the back plate 100 and the heat sink 110 are assembled, the screws are locked by a screw driver or other assistant tools. However, because the screws may be of different shapes and sizes, it takes too much time to select the screw driver or other tools, thus causing inconvenience in assembly. Moreover, when using the screw driver or other assistant tools, the assembly operation may be limited by the design of the structure of the product and the operating space, and may not be able to be carried out successfully. On the other hand, when the Plasma Display needs to be repaired or disassembled due to various reasons, the above problem also exists, thus consuming much time and labor in repair or disassembly.

### SUMMARY OF THE INVENTION

Accordingly, the object of the present invention is to provide a mounting button, which is suitable for locking two plates in a display module and provides quicker assembly or disassembly for improving the efficiency of production or repair.

The present invention provides a mounting button used in the display module, suitable for fixing the relative position of a first plate and a second plate in a display module. The first plate has a first opening and the second plate has a second opening corresponding to the first opening. The mounting button used in the display module comprises a shaft, a first sticking part, a second sticking part, and a spacing part. The first sticking part, the second sticking part, and the spacing part protrude from the shaft, and the spacing part is located between the first sticking part and the second sticking part. Particularly, when the first plate and the second plate are fixed by the mounting button, the shaft passes through the first opening and the second opening and rotates at an angle with respect to the first plate and the second plate, so that the spacing plate is supported between the first plate and the second plate. In another words, the first sticking part and the second sticking part can respectively clamp the first plate and the second plate.

According to the mounting button used in the display module of the preferred embodiment of the present invention, the first plate is, for example, an edging of a back plate.

According to the mounting button used in the display module of the preferred embodiment of the present invention, the second plate is, for example, a heat sink.

According to the mounting button used in the display module of the preferred embodiment of the present invention, when the shaft passes through the first opening and the second opening, the first sticking part passes through the first opening and the second opening in the axial direction of the shaft.

According to the mounting button used in the display module of the preferred embodiment of the present invention, when the shaft passes through the first opening and the second opening, the spacing part passes through the second opening in the axial direction of the shaft.

According to the mounting button used in the display module of the preferred embodiment of the present invention, the first sticking part has at least a protrusion with respect to the surface of the spacing part, so as to support the first plate.

According to the mounting button used in the display module of the preferred embodiment of the present invention, the outer edge of the protrusion is, for example, a chamfer.

According to the mounting button used in the display module of the preferred embodiment of the present invention, the chamfer is, for example, an oblique angle.

According to the mounting button used in the display module of the preferred embodiment of the present invention, the chamfer is, for example, a round angle.

According to the mounting button used in the display module of the preferred embodiment of the present invention, one side of the second sticking part, which is away from the shaft, extends towards the spacing part, so as to support the second plate.

According to the mounting button used in the display module of the preferred embodiment of the present invention, the mounting button is, for example, one-piece manufactured.

According to the mounting button used in the display module of the preferred embodiment of the present invention, the material of the mounting button includes one of NYLON, PU, TPEE, and TPE.

According to the mounting button used in the display module of the preferred embodiment of the present invention, a forcing portion disposed on one end of the shaft that is away from the first sticking part is further included.

According to the mounting button used in the display module of the preferred embodiment of the present invention, the forcing portion has, for example, multiple slots.

According to the mounting button used in the display module of the preferred embodiment of the present invention, the forcing portion is, for example, prism-shaped.

According to the mounting button including the forcing portion of the preferred embodiment of the present invention, the mounting button is, for example, one-piece manufactured.

According to the mounting button including the forcing portion of the preferred embodiment of the present invention, the material of the mounting button includes one of NYLON, PU, TPEE, and TPE.

With the mounting button used in the display module of the present invention, the relative position of a first plate and a second plate in a display module can be fixed. The mounting button has a first sticking part and a second sticking part for supporting the two plates, and a spacing part for keeping a distance between the two plates. Therefore, compared with the conventional locking manner using screws, the mounting button of the present invention permits easy and rapid assembly or disassembly, thus reducing the operating time of the operator and the manufacturing cost, and improving the efficiency of production or repair.

In order to the make the aforementioned and other objects, features, and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a partial schematic view of a conventional Plasma Display with its heat sink fin and back plate assembled.

FIGS. 2A˜2C are sequentially schematic views of assembling the back plate and the heat sink in the plasma display module of the preferred embodiment of the present invention.

FIG. 3 is a side schematic view of FIG. 2B.

FIG. 4 is a side schematic view of FIG. 2C.

### DESCRIPTION OF EMBODIMENTS

The mounting button of the present invention is suitable for fixing the relative position of the two plates in the display module. The assembling of the back plate and the heat sink in the Plasma Display are taken as an example in the following to illustrate the manner of assembly using the mounting button of the present invention. Of course, the application scope of the mounting button of the present invention is not limited herein. With reference to the following embodiments, it will be apparent to those skilled in the art that the present invention can be applied in assembly involving plates of other display apparatuses as required.

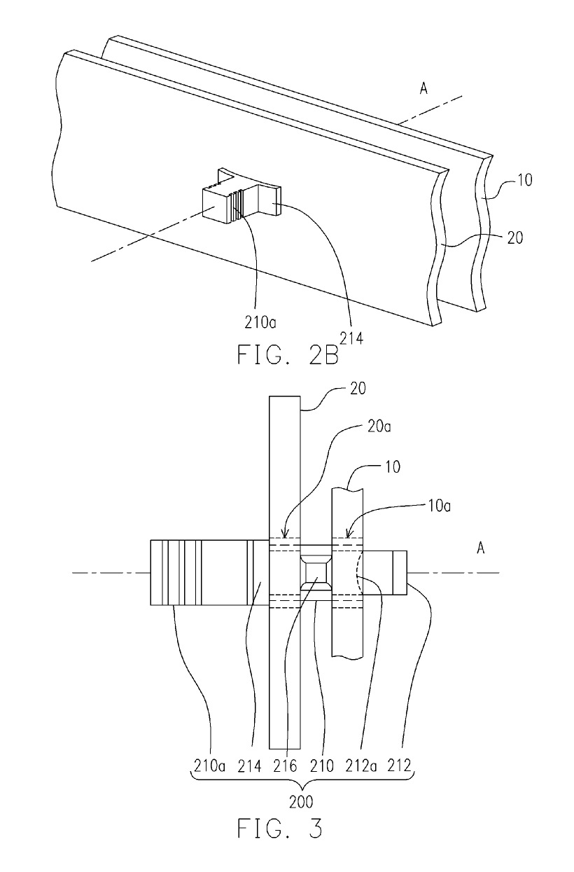

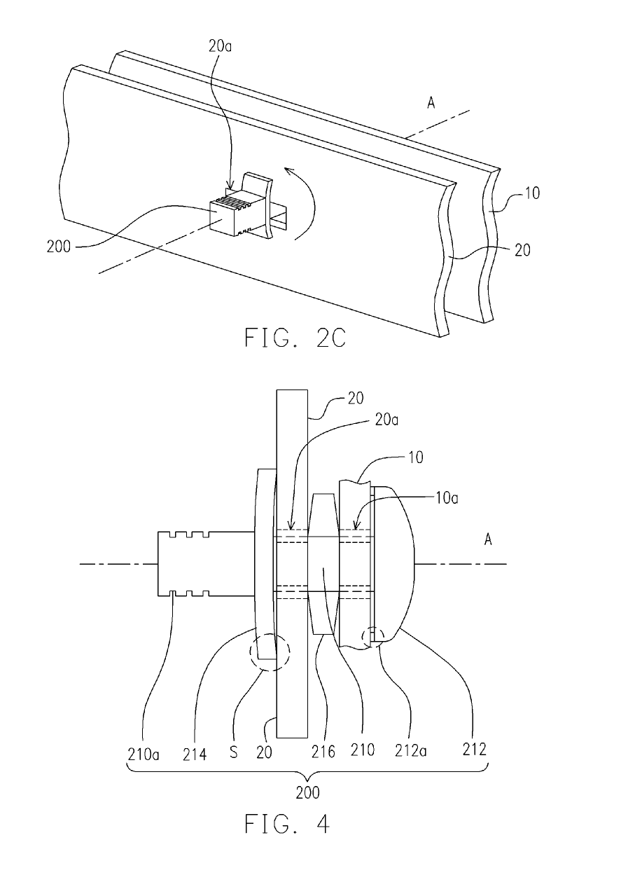

FIGS. 2A˜2C are sequentially schematic views of assembling the back plate and the heat sink in the plasma display module of the preferred embodiment of the present invention. Referring to FIG. 2A, a heat sink 20 is disposed on the outer side of the edging 10 of the back plate of the plasma display module, wherein a first opening 10a is provided on the edging 10, and a second opening 20a corresponding to the first opening 10a is provided on the heat sink 20. The mounting button 200 is adapted to pass through the second opening 20a and the first opening 10a sequentially in an axial direction A.

Moreover, the material of the mounting button 200 provided by the present invention includes, for example, one of NYLON, PU, TPEE, and TPE. And the mounting button 200 is, for example, one-piece manufactured.

Accordingly, the mounting button 200 includes a shaft 210, a forcing portion 210a, a first sticking part 212, a second sticking part 214, and a spacing part 216. The first sticking part 212, the second sticking part 214, and the spacing part 216 are all formed on the shaft 210 and protrude from the shaft 210. And the forcing portion 210a is disposed on one end of the shaft 210 that is away from the first sticking part 212. The forcing portion 210a is designed to be, for example, prism-shaped, and multiple slots can be formed, for example, on the forcing portion 210a, so that it is easy for the operator to hold. The slots are, for example, one-piece formed on the forcing portion 210a.

Moreover, the spacing part 216 is located between the first sticking part 212 and the second sticking part 214. In the present embodiment, the first sticking part 212, for example, has a protrusion 212a with respect to the surface of the spacing part 216. The outer edge of the protrusion 212a is designed to be a chamfer, for example, an oblique angle or a round angle. Furthermore, one side S of the second sticking part 214, which is away from the shaft 210, for example extends towards the spacing part 216. Of course, the shapes of the first sticking part 212 and the second sticking part 214 are not limited in the present invention, as long as the first sticking part 212 and the second sticking part 214 can be used to respectively support the edging 10 and the heat sink 20 (described in detail bellow).

Then, referring to FIG. 2B and FIG. 3, FIG. 3 is a side schematic view of FIG. 2B. In particular, when the mounting button 200 is used to assemble, the forcing portion 210a can be clamped directly by hands or appropriate dampers (not shown). The first sticking part 212 passes through the second opening 20a and the first opening 10a sequentially in the axial direction A of the shaft 210, and the spacing part 216 accordingly pass through the second opening 20a of the heat sink 20. In this manner, the edging 10 is located between the first sticking part 212 and the spacing part 216. And the heat sink 20 is located between the second sticking part 214 and the spacing part 216.

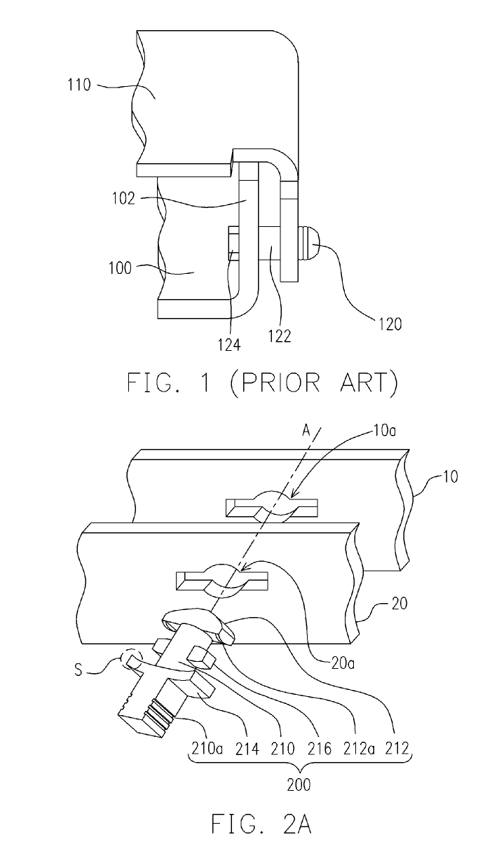

Then, referring to FIG. 2C and FIG. 4, FIG. 4 is a side schematic view of FIG. 2C. The mounting button 200 is rotated at an angle, and the preferred angle is, for example, 90 degrees or another degree that causes interference among the mounting button 200, the edging 10, and the heat sink 20. The first sticking part 212 is supported against the surface of the edging 10 by the protrusion 212a after rotating, so as to provide a pressure forcing the edging 10. Moreover, the spacing part 216 together with the first sticking part 212 clamps the edging 10 after rotating. It should be noted that if the outer edge of the protrusion 212a of the first sticking part 212 is designed to be a chamfer, the first sticking part 212 can be protected from hitting the first opening 10a while rotating, thus avoiding damage to the first sticking part 212. Moreover, the second sticking part 214 is supported against the heat sink 20 by one side S that is away from the shaft 210 in the rotating direction, so as to provide a pressure forcing the heat sink 20. And the spacing part 216 together with the second sticking part 214 clamps the heat sink 20 after rotating. On the other hand, because the spacing part 216 is supported between the edging 10 and the heat sink 20, the distance between the edging 10 and the heat sink 20 can be maintained. Compared with the conventional manner of assembly which needs an extra spacing nut 122 to be installed (referring to FIG. 1), the present invention can reduce the cost.

As for the mounting button 200 of the present invention, the relative position of the edging 10 and the heat sink 20 can be fixed and the distance there-between can be maintained after inserting and rotating the mounting button 200 at a fixed angle. Moreover, when the edging 10 and the heat sink 20 need to be disassembled due to repair or other reasons, the mounting button 200 can be removed from the edging 10 and the heat sink 20 by reversely taking the above actions. More particularly, firstly, the mounting button 200 is rotated at an appropriate angle. Then the mounting button 200 is drawn out reversely in the axial direction A, so as to separate the edging 10 and the heat sink 20.

As compared with the conventional locking manner using screws, the present invention permits easier assembly and disassembly, thereby improving the efficiency of capacity and reducing the man-hours needed for repair. It should be noted that some proper modifications can be made to the mounting button of the present invention as required. For example, multiple spacing parts for clamping more than two plates can be designed corresponding to the number of the plates.

To sum up, the mounting button of the present invention has at least the following advantages.

1. When the operator performs assembly or disassembly using the mounting button of the present invention, the number of assistant tools used can be reduced or the assembly or disassembly can be directly done by hand. Therefore, the present invention can reduce the man-hours required of operators performing assembly and disassembly and improve the efficiency of capacity and the pace of repair work.

2. As for the mounting button of the present invention, the spacing part is directly formed on the shaft, and extra parts are not required to space the two plates. Therefore, the production cost can be reduced and the assembly flow can be simplified.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mounting button used in a display module, suitable for fixing the relative position of a first plate and a second plate in a display module, wherein the first plate has a first opening and the second plate has a second opening corresponding to the first opening, the mounting button used in the display module comprising:
a shaft;
a first sticking part, protruding from the shaft;
a second sticking part, protruding from the shaft; and
a spacing part, protruding from the shaft and located between the first sticking part and the second sticking part, wherein when the first plate and the second plate are fixed by the mounting button, the shaft passes through the first opening and the second opening and rotates at an angle with respect to the first plate and the second plate, so that the spacing plate is supported between the first plate and the second plate, and clamps the first plate and the second plate with the first sticking part and the second sticking part respectively.

2. The mounting button used in a display module as claimed in claim 1, wherein the first plate is an edging of a back plate.

3. The mounting button used in a display module as claimed in claim 1, wherein the second plate is a heat sink.

4. The mounting button used in a display module as claimed in claim 1, wherein when the shaft passes through the first opening and the second opening, the first sticking part passes through the first opening and the second opening in the axial direction of the shaft.

5. The mounting button used in a display module as claimed in claim 1, wherein when the shaft passes through the first opening and the second opening, the spacing part passes through the second opening in the axial direction of the shaft.

6. The mounting button used in a display module as claimed in claim 1, wherein the first sticking part has at least a protrusion with respect to the surface of the spacing part, so as to support the first plate.

7. The mounting button used in a display module as claimed in claim 6, wherein the outer edge of the protrusion has a chamfer.

8. The mounting button used in a display module as claimed in claim 6, wherein the chamfer is an oblique angle.

9. The mounting button used in a display module as claimed in claim 6, wherein the chamfer is a round angle.

10. The mounting button used in a display module as claimed in claim 1, wherein one side of the second sticking part, which is away from the shaft, extends towards the spacing part, so as to support the second plate.

11. The mounting button used in a display module as claimed in claim 1, wherein the mounting button is one-piece manufactured.

12. The mounting button used in a display module as claimed in claim 1, wherein the material of the mounting button includes one of NYLON, PU, TPEE, and TPE.

13. The mounting button used in a display module as claimed in claim 1, further comprising a forcing portion disposed on one end of the shaft that is away from the first sticking part.

14. The mounting button used in a display module as claimed in claim 13, wherein the forcing portion has multiple slots.

15. The mounting button used in a display module as claimed in claim 13, wherein the forcing portion is prism-shaped.

16. The mounting button used in a display module as claimed in claim 13, wherein the mounting button is one-piece manufactured.

17. The mounting button used in a display module as claimed in claim 13, wherein the material of the mounting button includes one of NYLON, PU, TPEE, and TPE.
